(19) United States
(12) Patent Application Publication
(10) Pub. No.: US 2026/0330664 A1
(43) Pub. Date: Oct. 22, 2026

(54) TRAINING DATASET GENERATION SYSTEM, ESTIMATION MODEL GENERATION UNIT, SHAPE ESTIMATION DEVICE, AND TRAINING DATASET GENERATION METHOD

(71) Applicant: JVCKENWOOD Corporation, Kanagawa (JP)

(72) Inventor: Mutsumi YAMAMOTO, Yokohama-shi (JP)

(21) Appl. No.: 19/713,109

(22) Filed: Jun. 18, 2026

Related U.S. Application Data
(63) Continuation of application No. PCT/JP2024/040490, filed on Nov. 14, 2024.

(30) Foreign Application Priority Data
Dec. 22, 2023 (JP) 2023-216436

(51) Int. Cl. G06T 7/50

(52) U.S. Cl. CPC G06T 7/50; G06T 2207/20081

(57) ABSTRACT

A training dataset generation system includes a shape extraction device that acquires a distance measurement image of a learning target and extracts a specific shape based on the distance measurement image, and a training dataset generation device that generates a training dataset by associating an RGB image of the learning target with the specific shape.

### TECHNICAL FIELD

The present invention relates to a training dataset generation system, an estimation model generation unit, a shape estimation device, and a training dataset generation method.

### CROSS REFERENCE TO RELATED APPLICATION

This application is a bypass continuation of PCT/JP2024/040490, filed on Nov. 14, 2024, which priority is claimed on Japanese Patent Application No. 2023-216436, filed Dec. 22, 2023, the content of both of which is incorporated herein by reference.

### BACKGROUND ART

In order to photograph a subject, a camera suitable for the purpose of photographing is used. For example, an RGB camera that performs imaging in a visible light region may be used for capturing the brightness and color of a subject. Further, in order to measure the distance to a subject, a time of flight (ToF) camera or the like may be used. For example, Patent Document 1 discloses a method of acquiring a depth image of a scene using a depth sensor and extracting a plane from the depth image.

Thus, for example, when brightness, color, and shapes such as a plane of a subject are acquired, both an RGB camera and a ToF camera are used.

### CITATION LIST

### Patent Document

Patent Document 1: Japanese Unexamined Patent Application, First Publication No. 2016-212086

### SUMMARY OF INVENTION

### Technical Problem

However, since two cameras are used, a cost becomes higher compared with a case in which one camera is used as in ordinary photographing.

An object of the present invention is to provide a training dataset generation system, an estimation model generation unit, a shape estimation device, and a training dataset generation method for estimating a shape based on an RGB image.

[1] An aspect of the present embodiment is an estimation model generation unit including a training a model to extract planes from a RGB image using a training dataset generated by a training dataset generation system, the training dataset generation system comprising, a shape extraction device configured to acquire a distance measurement image of a learning target and extract a specific shape based on the distance measurement image; and a training dataset generation device configured to generate a training dataset by associating an RGB image of the learning target with the specific shape, the estimation model generation unit does not use a training dataset containing the RGB image for training when a value indicating a brightness of the RGB image is at or below a predetermined value.

According to the present embodiment, it is possible to estimate a shape based on an RGB image.

### BRIEF DESCRIPTION OF DRAWINGS

FIG. 1 A diagram illustrating the configuration of a training dataset generation system according to the present embodiment.

FIG. 2 A diagram illustrating an example of the configuration of a camera according to the present embodiment.

FIG. 3 A diagram illustrating an example of the configuration of a camera according to the present embodiment.

FIG. 4 A diagram illustrating an example of an RGB image captured by the camera.

FIG. 5 A diagram illustrating an example of a method of extracting a plane.

FIG. 6 A diagram illustrating the configuration of a training dataset generation device according to the present embodiment.

FIG. 7 A flowchart illustrating an operation of the training dataset generation system according to the present embodiment.

FIG. 8 A diagram illustrating the configuration of an RGB image shape estimation model generation device according to the present embodiment.

FIG. 9 A flowchart illustrating an operation of the RGB image shape estimation model generation device according to the present embodiment.

FIG. 10 A top view illustrating a case in which parallel light is incident on a plane and a curved surface.

FIG. 11 A front view illustrating a case in which parallel light is incident on a plane and a curved surface.

FIG. 12 A diagram illustrating the configuration of a shape estimation system according to the present embodiment.

FIG. 13 A diagram illustrating the configuration of an RGB image shape estimation device according to the present embodiment.

FIG. 14 A flowchart illustrating an operation of the shape estimation system according to the present embodiment.

FIG. 15 is an internal block diagram illustrating an example of internal configurations of respective devices included in the training dataset generation system according to the present embodiment.

### DESCRIPTION OF EMBODIMENTS

### Overview of System

In the related art, for example, there is a detection system that acquires a distance measurement image including information on the distance to a ToF camera using a ToF camera including a ToF sensor and extracts a shape of a subject based on the distance information. According to the detection system of the related art configured as described above, it is possible to extract the shape of the subject.

On the other hand, when brightness and color information of the subject are acquired together, the detection system of the related art described above has a problem in that a system configuration becomes complicated and cost of the detection system cannot be reduced because two types of cameras including an RGB camera and a ToF camera are used.

Here, when the shape of the subject can be determined based on an image captured by the RGB camera, the ToF camera may be omitted from the detection system.

However, in general, since the image captured by the RGB camera does not include distance information captured by the ToF camera, the shape of the subject cannot be determined with high accuracy using only the image captured by the RGB camera in some cases.

Therefore, in the present embodiment, it is proposed to determine a shape based on the image captured by the RGB camera with accuracy similar to a case in which an image is captured by the ToF camera by learning, through machine learning or the like, a correspondence relationship between a shape extracted from the image captured by the ToF camera and the image captured by the RGB camera corresponding to the shape.

When machine learning is performed, generally, how training data can be efficiently generated becomes a problem. In the present embodiment, the training data is shape information of a learning target (for example, an interior of a room).

In the present embodiment, a combination of shape information, which is training data, and an RGB image captured by the RGB camera is referred to as a training dataset.

Hereinafter, respective functional configurations will be described in order of a training dataset generation system 1 that generates the training dataset, an RGB image shape estimation model generation device 20 that generates a shape estimation model using the RGB image based on the training dataset generated by the training dataset generation system 1, and an RGB image shape estimation device 32 that estimates a shape based on the shape estimation model generated by the RGB image shape estimation model generation device 20.

### Training Dataset Generation

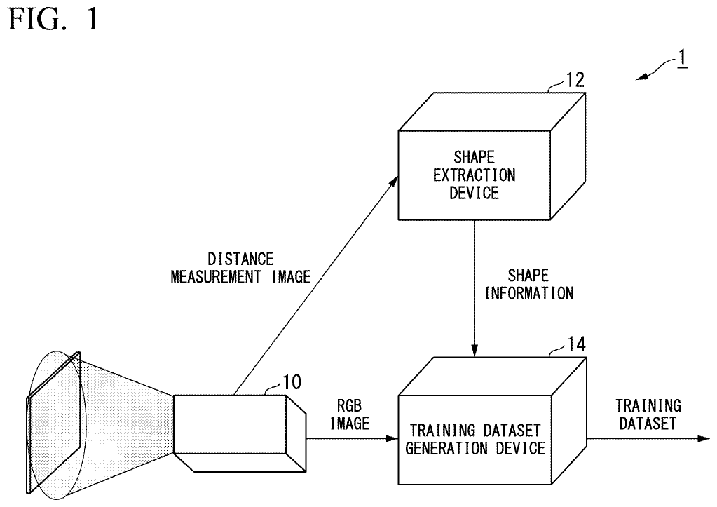

FIG. 1 is a diagram illustrating the configuration of a training dataset generation system 1 according to the present embodiment. The training dataset generation system 1 is a system that generates a dataset in which an RGB image of a learning target is associated with shape information. The training dataset generation system 1 includes a camera 10, a shape extraction device 12, and a training dataset generation device 14.

Here, the learning target is, for example, an interior of a room.

The training dataset generation system 1 according to the present embodiment may be configured by adding the training dataset generation device 14 to a conventionally existing detection system.

The camera 10 captures an RGB image and a distance measurement image of the learning target. That is, the camera 10 has functions of both the RGB camera and the ToF camera. The camera 10 outputs the captured RGB image to the training dataset generation device 14. The camera 10 outputs the captured distance measurement image to the shape extraction device 12.

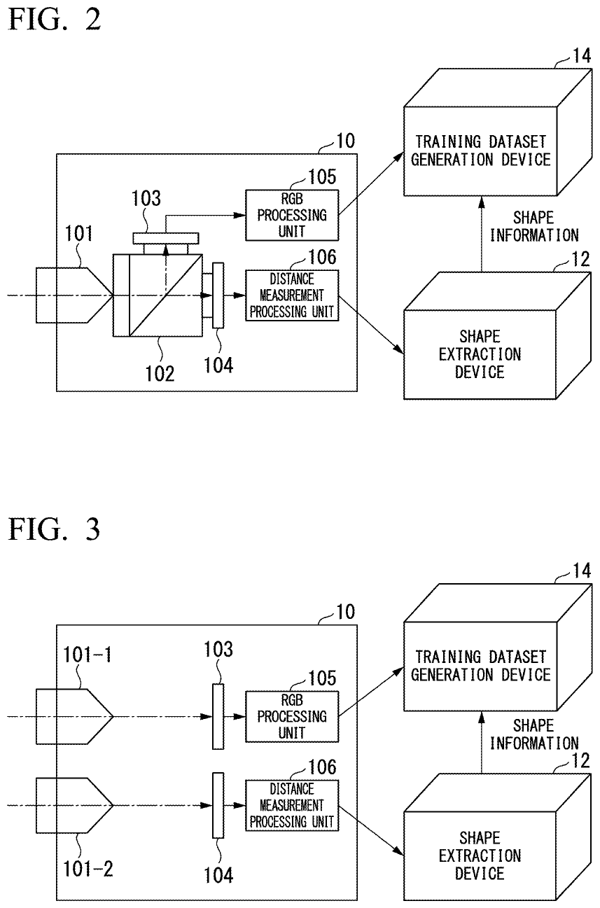

Preferably, the camera 10 captures the RGB image and the distance measurement image on the same optical axis. FIG. 2 is a diagram illustrating an example of a configuration of the camera 10 according to the present embodiment. The camera 10 includes a lens 101, a prism 102, an RGB sensor 103, a ToF sensor 104, an RGB processing unit 105, and a distance measurement processing unit 106. In the camera 10 illustrated in FIG. 2, light entering the lens 101 is spectrally separated by the prism 102, visible light is input to the RGB sensor 103, and infrared light is input to the ToF sensor 104. The RGB sensor 103 detects red light, green light, and blue light of the input light, and the RGB processing unit 105 performs processing to generate an RGB image.

The ToF sensor 104 determines the distance to the learning target by determining a time until output infrared light is reflected and returns. The distance measurement processing unit 106 generates a distance measurement image including information on the distance to the learning target. The distance measurement image is, for example, point cloud data and is a set of points including three-dimensional position information. The ToF sensor 104 only needs to acquire the distance to the learning target and may be another type of sensor.

The camera 10 may capture the RGB image and the distance measurement image at close angles that may be regarded as substantially the same optical axis. FIG. 3 is a diagram illustrating an example of a configuration of the camera 10 according to the present embodiment. The camera 10 includes two lenses 101-1 and 101-2, an RGB sensor 103, a ToF sensor 104, an RGB processing unit 105, and a distance measurement processing unit 106. In FIG. 3, light entering the lens 101-1 is input to the RGB sensor 103. In FIG. 3, infrared light entering the lens 101-2 is input to the ToF sensor 104. Operations of the RGB sensor 103, the ToF sensor 104, the RGB processing unit 105, and the distance measurement processing unit 106 in FIG. 3 are the same as operations of the RGB sensor 103, the ToF sensor 104, the RGB processing unit 105, and the distance measurement processing unit 106 in FIG. 2. An optical axis of light incident on the RGB sensor 103 and an optical axis of light incident on the ToF sensor 104 face the same direction and are close to each other. Accordingly, the optical axes may be said to be substantially the same optical axis. Hereinafter, when the optical axes are referred to as the same optical axis, a substantially same optical axis case is also included. When a correspondence relationship between pixels of images acquired by the RGB sensor 103 and the ToF sensor 104 is misaligned, the images may be corrected so that the correspondence relationships between the pixels match.

The shape extraction device 12 acquires a distance measurement image from the camera 10. The shape extraction device 12 extracts a shape based on the distance measurement image. The shape extraction device 12 outputs shape information to the training dataset generation device 14. The shape information is information relating to a type of extracted shape or a position of the extracted shape.

The type of shape is, for example, a plane or a curved surface. As the type of shape, a curved surface may include a spherical surface or a side surface of a cylinder. The type of shape may include a three-dimensional object (such as a triangular prism or a triangular pyramid) formed by combining planes. The information relating to the position of the shape is represented, for example, by coordinates in a predetermined reference system. The information relating to the position of the shape may be a set of points included in a specific shape or may be a set of points forming an outline of the specific shape.

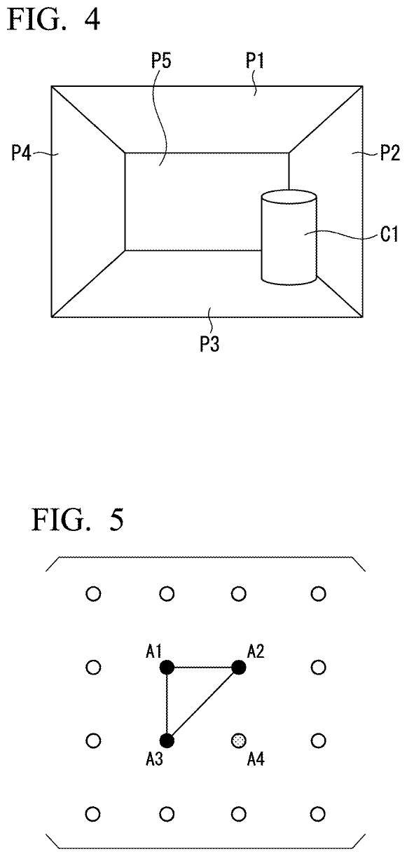

FIG. 4 is an example of the RGB image captured by the camera 10.

In the example illustrated in FIG. 4, subjects (learning targets) of the camera 10 are a ceiling P1, a first wall P2, a floor P3, a second wall P4, a third wall P5, and a column C1 of an interior of a room. The RGB image illustrated in FIG. 4 is an image captured when the camera 10 faces the third wall P5.

Hereinafter, a method of extracting a plane from point cloud data will be described with reference to FIG. 5.

First, for one point A1, two adjacent points are selected. Here, the selected two points are selected such that three points including the two points and the point A1 are not located on one straight line. The selected two points are referred to as A2 and A3.

Thereafter, an infinite plane including the three points A1, A2, and A3 is considered. The infinite plane is set as a reference plane. Thereafter, the distance between a point A4 adjacent to the point A1, A2, or A3 and the reference plane is calculated. Here, when the calculated distance is smaller than a predetermined value d, it is determined that the point A4 also forms the same plane as the points A1, A2, and A3. Here, when the calculated distance is equal to or greater than the predetermined value d, it is determined that the point A4 does not form the same plane as the points A1, A2, and A3, and the same calculation is performed on an adjacent point different from the point A4 to determine whether the adjacent point forms the same plane as the points A1, A2, and A3.

When it is determined that the point A4 constitutes the same plane as the points A1, A2, and A3, the reference plane is updated by setting, as the reference plane, an infinite plane in which the total of distances from the four points A1, A2, A3, and A4 becomes minimum. After the reference plane is updated, the distance from the reference plane to a point adjacent to the four points A1, A2, A3, and A4 is calculated, and it is determined whether the distance is smaller than the predetermined value d.

By continuing the above processing, finally, there are no adjacent points to which the distance from the reference plane is to be calculated. Accordingly, a plane including the point A1 is determined.

It is possible to extract all planes included in a point cloud by sequentially performing this processing on points not included in the determined plane.

A lower limit may be provided for the number of points constituting the same plane, and a plane constituted by a number of points below the lower limit may not be recognized as a plane.

The shape extraction device 12 can extract a plane from point cloud data using the above method. The method of extracting a plane is not limited to the above method, and may be, for example, another known scheme (such as RANSAC).

The shape extraction device 12 can extract both a facing plane and a non-facing plane using the above method. Using this method, in the example illustrated in FIG. 4, the shape extraction device 12 extracts the facing P5 and the non-facing ceiling P1, first wall P2, floor P3, and second wall P4 as planes.

The shape extraction device 12 extracts, for example, as the curved surface, a set of points not extracted as the plane. In the example illustrated in FIG. 4, the shape extraction device 12 extracts a side surface of the column C1 as the curved surface.

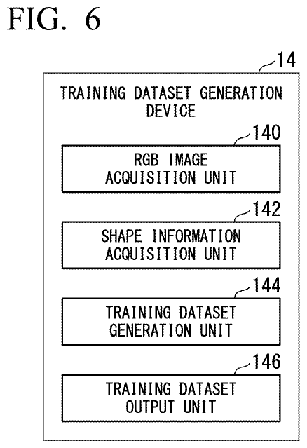

The training dataset generation device 14 generates a training dataset based on the RGB image of the same learning target and the shape information. FIG. 6 is a diagram illustrating a configuration of the training dataset generation device 14 according to the present embodiment. The training dataset generation device 14 includes an RGB image acquisition unit 140, a shape information acquisition unit 142, a training dataset generation unit 144, and a training dataset output unit 146.

The RGB image acquisition unit 140 acquires the RGB image of the learning target from the camera 10.

The shape information acquisition unit 142 acquires the shape information of the learning target from the shape extraction device 12.

The training dataset generation unit 144 generates a training dataset by associating the RGB image of the learning target acquired by the RGB image acquisition unit 140 with the shape information acquired by the shape information acquisition unit 142. In the training dataset, by associating the RGB image with the shape information, a type of shape of an object appearing in the RGB image and a position of the shape are specified.

The training dataset output unit 146 outputs the training dataset. The training dataset is input to an RGB image shape estimation model generation device 20 to be described later.

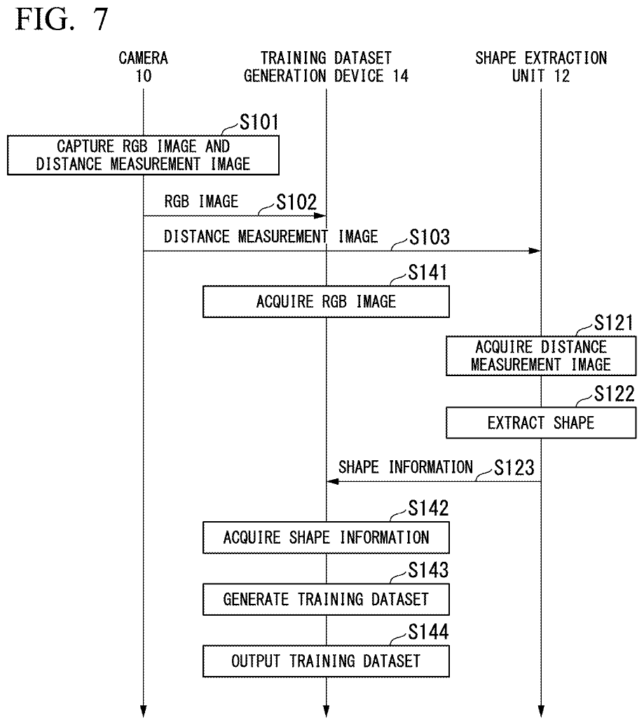

FIG. 7 is a flowchart illustrating an operation of the training dataset generation system 1 according to the present embodiment. The camera 10 captures the RGB image of the learning target and the distance measurement image (step S101). The camera 10 outputs the RGB image to the training dataset generation device 14 (step S102). The camera 10 outputs the distance measurement image to the shape extraction device 12 (step S103). The training dataset generation device 14 acquires the RGB image output by the camera 10 (step S141). The shape extraction device 12 acquires the distance measurement image output by the camera 10 (step S121). The shape extraction device 12 extracts the shape based on the distance measurement image (step S122). The shape extraction device 12 outputs shape information to the training dataset generation device 14 (step S123).

The training dataset generation device 14 acquires the shape information output by the shape extraction device 12 (step S142). The training dataset generation device 14 generates a training dataset in which the RGB image and the shape information are associated with each other (step S143). The training dataset generation device 14 outputs the training dataset (step S144).

As described above, the training dataset generation device 14 can generate the training dataset in which the RGB image and the shape information are associated with each other.

Further, the training dataset generation system 1 can be created by adding a configuration for acquiring an RGB image (the RGB sensor 103 and the RGB processing unit 105) and the training dataset generation device 14 to a system of the related art that acquires a distance measurement image and estimates a type of shape and a position of the shape from the distance measurement image.

Further, by capturing the RGB image and the distance measurement image on the same optical axis using the camera 10, a shape indicated by the RGB image in the training data and a shape extracted from the distance measurement image appear at the same position without any misalignment. Accordingly, using the generated training dataset, it is possible to increase accuracy of an estimation model that estimates shape information based on the RGB image.

### Estimation Model Generation Device

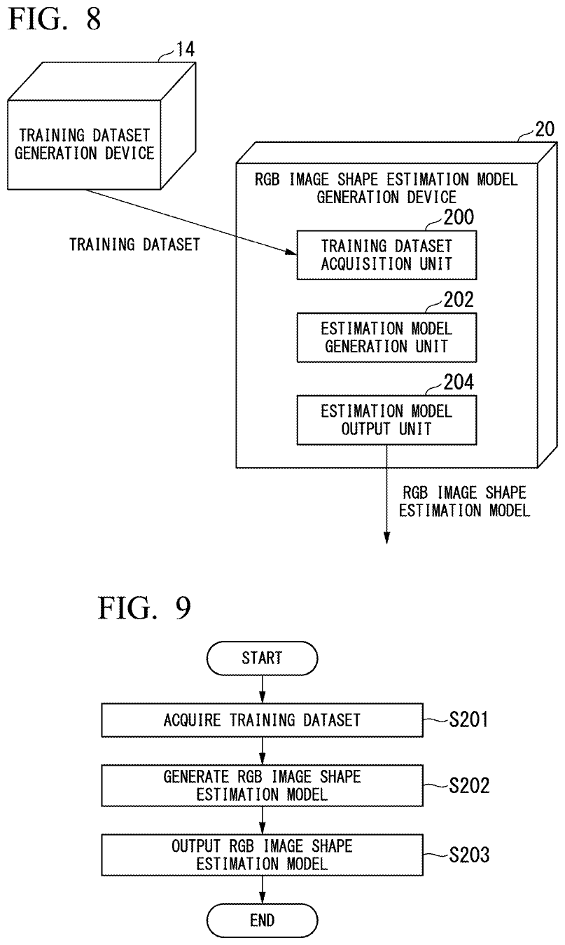

FIG. 8 is a diagram illustrating a configuration of the RGB image shape estimation model generation device 20 according to the present embodiment. The RGB image shape estimation model generation device 20 includes a training dataset acquisition unit 200, an estimation model generation unit 202, and an estimation model output unit 204.

The training dataset acquisition unit 200 acquires the training dataset from the training dataset generation device 14. The estimation model generation unit 202 generates an RGB image shape estimation model by performing learning using the training dataset. The RGB image shape estimation model is a model that estimates a type of shape and a position of the shape of a subject by inputting an RGB image. A learning method is not particularly limited, and the RGB image shape estimation model is, for example, a neural network.

The estimation model output unit 204 outputs the generated RGB image shape estimation model.

FIG. 9 is a flowchart illustrating an operation of the RGB image shape estimation model generation device 20 according to the present embodiment. The training dataset acquisition unit 200 acquires a training dataset from the training dataset generation device 14 (step S201). The estimation model generation unit 202 generates an RGB image shape estimation model by performing learning using the training dataset (step S202). The estimation model output unit 204 outputs the RGB image shape estimation model (step S203).

When the shape is a plane and when the shape is a curved surface, appearances of the RGB image are different. When parallel light is incident on the plane, angles with respect to the plane are the same, and thus, light energy per unit area on the plane becomes equal. Assuming that the incident light is diffused in equal directions, magnitudes of brightness of the plane become equal.

When the parallel light is incident on the curved surface, angles are different depending on incidence places, light energy per unit area differs depending on the places and magnitudes of brightness are different, thereby causing unevenness.

Therefore, it is considered that it is possible to create a model for estimating a position at which a shape is a plane or a curved surface based on an RGB image by learning position information indicating that the shape is a plane or a curved surface and unevenness of brightness in the RGB image.

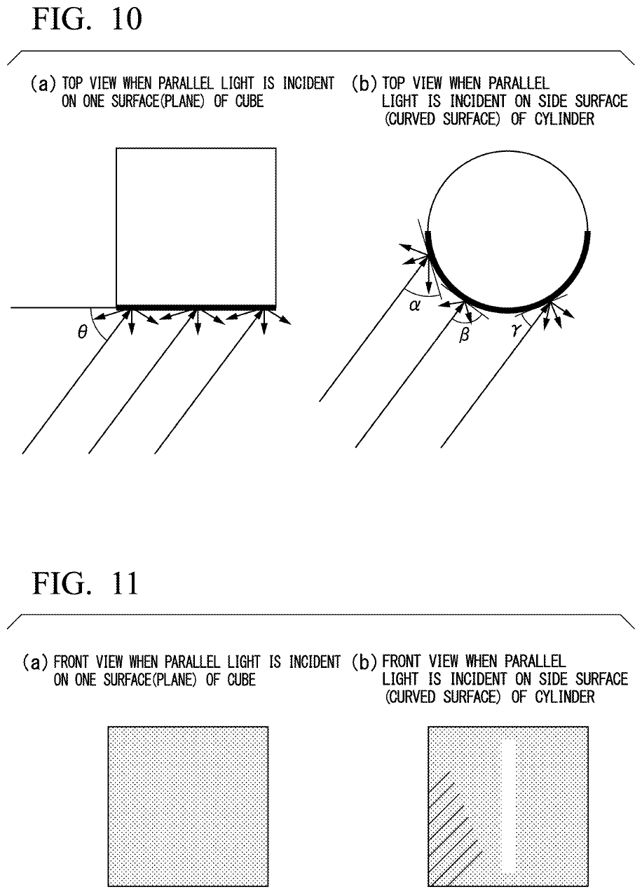

FIG. 10 is a top view when parallel light is incident on the plane and the curved surface. (a) of FIG. 10 illustrates reflection when parallel light is incident on one surface of a cube as the plane, and (b) of FIG. 10 illustrates reflection when parallel light is incident on a side surface of a cylinder as the curved surface. In the example illustrated in (a) of FIG. 10, three parallel light rays are all incident on the plane at the same angle θ. Therefore, the light energy per unit area becomes equal, and assuming that the incident light is diffused in equal directions, the magnitudes of brightness on the plane become equal. On the other hand, in the example illustrated in (b) of FIG. 10, three parallel light rays are incident on the curved surface at angles α, β, and γ, respectively. Therefore, light energy per unit area differs, and magnitudes of brightness differ.

FIG. 11 is a front view when parallel light is incident on a plane and a curved surface. (a) of FIG. 11 is a front view when parallel light is incident on one surface of a cube as a plane, and (b) of FIG. 11 is a front view when parallel light is incident on a side surface of a cylinder as a curved surface. As illustrated in (b) of FIG. 11, when the parallel light is incident on the curved surface, magnitude of brightness differs depending on a region on which the light is incident, and thus, unevenness occurs in brightness in an RGB image obtained by photographing the curved surface. On the other hand, as illustrated in (a) of FIG. 11, when the parallel light is incident on the plane, the magnitude of brightness does not change depending on the region on which the light is incident, and thus, unevenness does not occur in brightness in the RGB image obtained by photographing the curved surface.

In the present embodiment, since it is considered that the unevenness of the brightness in the RGB image is learned, it is desirable that the brightness in the RGB image be greater than a preset predetermined value. When a value indicating the brightness in the RGB image (for example, an average value, a maximum value, or a minimum value of brightness) is equal to or less than the predetermined value, the estimation model generation unit 202 may not use training data including the RGB image for learning. Accordingly, an RGB image when a photographing target is a black object or an object coated with a non-reflective coating and has low reflectance can be excluded from a training dataset to be learned.

### Shape Estimation System

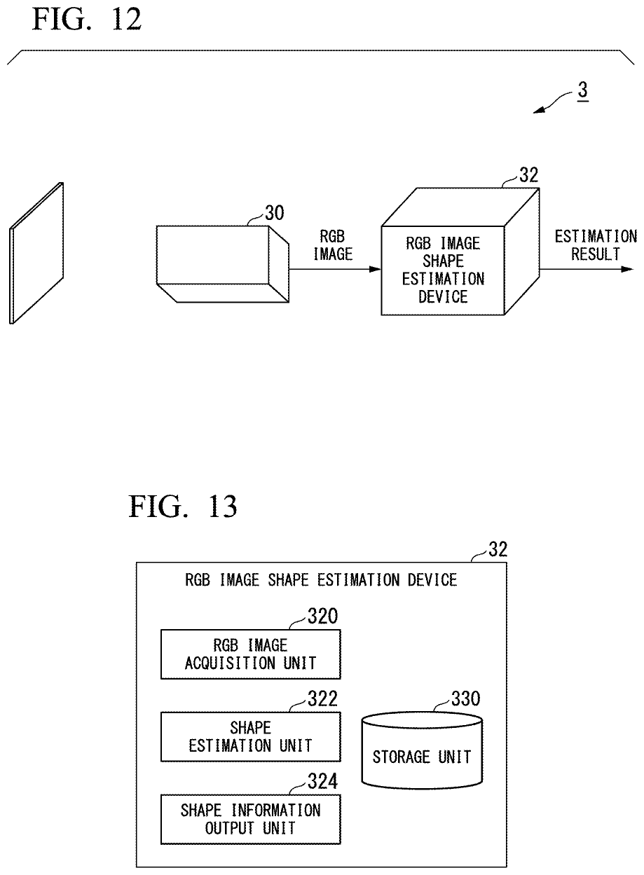

FIG. 12 is a diagram illustrating the configuration of a shape estimation system 3 according to the present embodiment. The shape estimation system 3 includes an RGB camera 30 and an RGB image shape estimation device 32.

The RGB camera 30 photographs an estimation target and captures an RGB image. The RGB camera 30 outputs the captured RGB image to the RGB image shape estimation device 32. The RGB image shape estimation device 32 estimates and outputs a type and a position of a shape of the RGB image based on the RGB image. The shape estimation system 3 is used to photograph the interior of the room and estimate positions of walls and the like of the interior.

FIG. 13 is a diagram illustrating a configuration of the RGB image shape estimation device 32 according to the present embodiment. The RGB image shape estimation device 32 includes an RGB image acquisition unit 320, a shape estimation unit 322, a shape information output unit 324, and a storage unit 330. The storage unit 330 stores an RGB image shape estimation model output by the RGB image shape estimation model generation device 20.

The RGB image acquisition unit 320 acquires an RGB image from the RGB camera 30.

The shape estimation unit 322 estimates a type of shape and a position of the shape based on the RGB image using the RGB image shape estimation model. The shape estimation unit 322 estimates the type and the position of the shape by inputting the RGB image to the RGB image shape estimation model and causing an estimation result of the type and the position of the shape to be output.

The shape information output unit 324 outputs the estimated shape information (the type and the position of the shape).

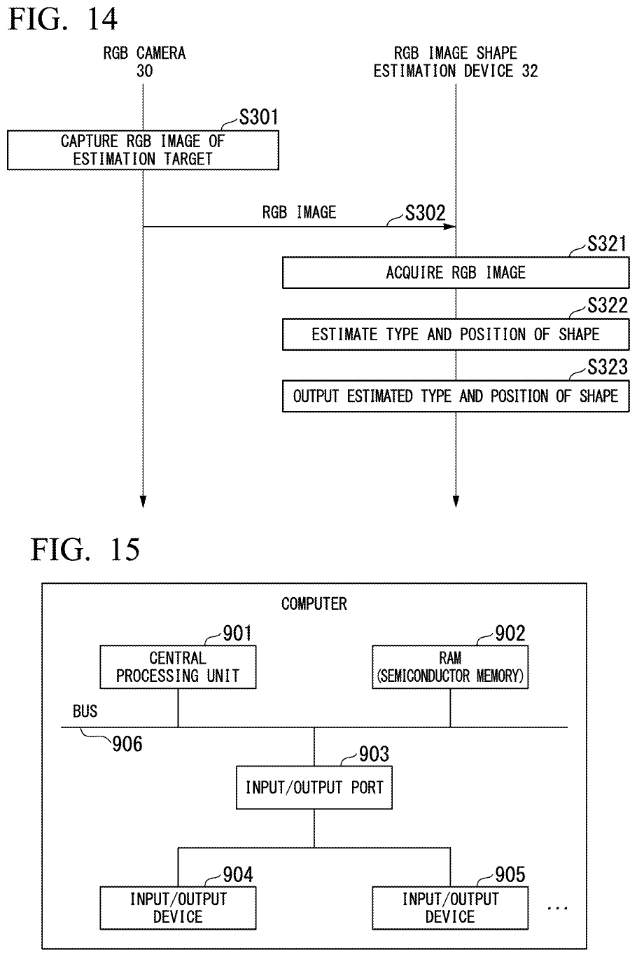

FIG. 14 is a flowchart illustrating an operation of the shape estimation system 3 according to the present embodiment. The RGB camera 30 captures the RGB image of the estimation target (step S301). The RGB camera 30 outputs the RGB image to the RGB image shape estimation device 32 (step S302).

The RGB image acquisition unit 320 acquires the RGB image from the RGB camera 30 (step S321). The shape estimation unit 322 estimates the type and the position of the shape based on the RGB image using the RGB image shape estimation model (step S322). The shape information output unit 324 outputs the estimated type and position of the shape (step S323).

As described above, the shape estimation system 3 can estimate a type and a position of a shape of the estimation target based on the RGB image. In the shape estimation system 3, it is possible to inspect color of the estimation target based on the RGB image, in addition to estimating the type and the position of the shape of the estimation target based on the RGB image. The shape estimation system 3 can perform not only inspection of the color of the estimation target but also estimation of the shape merely by capturing the RGB image.

### Other Embodiments

Although the embodiment of the present invention has been described above in detail with reference to the drawings, a specific configuration is not limited to the above-described configuration, and various design changes and the like can be made without departing from the gist of the present invention.

### Internal Configuration

FIG. 15 is an internal block diagram illustrating an example of an internal configuration of respective devices included in the training dataset generation system according to the present embodiment. As illustrated in the drawing, functions of at least some of the respective devices included in the training dataset generation system 1 (the shape extraction device 12, the training dataset generation device 14, the RGB image shape estimation model generation device 20, and the RGB image shape estimation device 32) may be realized using a computer. As illustrated, the computer includes a central processing unit 901, a RAM 902, an input/output port 903, input/output devices 904 and 905, and a bus 906. The computer itself can be realized using existing technology. The central processing unit 901 executes instructions included in a program read from the RAM 902 or the like. The central processing unit 901 writes data to the RAM 902, reads data from the RAM 902, or performs arithmetic operations or logical operations according to respective instructions. The RAM 902 stores data and programs. Each element included in the RAM 902 has an address and can be accessed using the address. The RAM is an abbreviation for “random access memory.” The input/output port 903 is a port for allowing the central processing unit 901 to exchange data with an external input/output device and the like. The input/output device 904 or 905 is an input/output device. The input/output device 904 or 905 exchanges data with the central processing unit 901 via the input/output port 903. The bus 906 is a common communication path that is used inside the computer. For example, the central processing unit 901 reads or writes data of the RAM 902 via the bus 906. Further, for example, the central processing unit 901 accesses the input/output port via the bus 906. Further, all or some of functional units included in each device may be realized using hardware such as an ASIC, a PLD, or an FPGA. Further, all or some of the functional units may be realized by a combination of software and hardware.

The processing of the shape extraction device 12, the training dataset generation device 14, the RGB image shape estimation model generation device 20, or the RGB image shape estimation device 32 in the above-described embodiment may be realized by a computer using software. In this case, a program for realizing this function may be recorded on a computer-readable recording medium, and may be realized by causing a computer system to read and execute the program recorded on the recording medium. Here, the “computer system” includes an OS and hardware such as peripheral devices. Further, the “computer-readable recording medium” refers to a portable medium such as a flexible disk, a magneto-optical disk, a ROM, or a CD-ROM, and a storage device such as a hard disk incorporated in a computer system. Further, the “computer-readable recording medium” may include a medium that dynamically holds a program for a short time, such as a communication line when a program is transmitted via a network such as the Internet or a communication line such as a telephone line, and a medium that holds a program for a certain time, such as a volatile memory inside a computer system serving as a server or a client in that case. Further, the program may be one for realizing some of the above-described functions, may be one capable of realizing the above-described functions in combination with a program already recorded in a computer system, or may be one realized using a programmable logic device such as a field programmable gate array (FPGA).

### INDUSTRIAL APPLICABILITY

According to the present invention, it is possible to estimate a shape based on an RGB image.

### REFERENCE SIGNS LIST

1 Training dataset generation system
10 Camera
101 Lens
102 Prism
103 RGB sensor
104 ToF sensor
105 RGB processing unit
106 Distance measurement processing unit
12 Shape extraction device
14 Training dataset generation device
140 RGB image acquisition unit
142 Shape information acquisition unit
144 Training dataset generation unit
146 Training dataset output unit
20 RGB image shape estimation model generation device
200 Training dataset acquisition unit
202 Estimation model generation unit
204 Estimation model output unit
3 Shape estimation system
30 RGB camera
32 RGB image shape estimation device
320 RGB image acquisition unit
322 Shape estimation unit
324 Shape information output unit
330 Storage unit

What is claimed is

1. An estimation model generation unit comprising:
training a model to extract planes from a RGB image using a training dataset generated by a training dataset generation system,
the training dataset generation system comprising,
a shape extraction device configured to acquire a distance measurement image of a learning target and extract a specific shape based on the distance measurement image; and
a training dataset generation device configured to generate a training dataset by associating an RGB image of the learning target with the specific shape,
the estimation model generation unit does not use a training dataset containing the RGB image for training when a value indicating a brightness of the RGB image is at or below a predetermined value.

2. The estimation model generation unit according to claim 1,
wherein the specific shape is a plane.

3. The estimation model generation unit according to claim 1,
wherein the distance measurement image is point cloud data, and
the shape extraction device extracts a plane as the specific shape based on a distance between a plane determined by points included in the point cloud data and another point.

4. The estimation model generation unit according to claim 3,
wherein the shape extraction device determines that other points constitute the plane when a distance between a plane determined by points included in the point cloud data and the other points is equal to or less than a predetermined value, and extracts the plane as the specific shape.

5. The estimation model generation unit according to claim 4,
wherein, when the shape extraction device determines that there are other points constituting the plane, the shape extraction device resets the plane such that distances from all points constituting the plane become smallest.

6. The estimation model generation unit according to claim 1,
wherein the RGB image and the distance measurement image are acquired on the same optical axis.

7. A shape estimation device configured to estimate the shape from the RGB image of an estimation target using the RGB image shape estimation model estimated by the estimation model generation unit according to claim 1.

8. A estimation model generation method comprising:
training a model to extract planes from a RGB image using a training dataset generated by a training dataset generation method,
the training dataset generation method comprising,
a shape extraction step of acquiring a distance measurement image of a learning target and extracting a specific shape based on the distance measurement image; and
a training dataset generation step of generating a training dataset by associating an RGB image of the learning target with the specific shape,
the estimation model generation method does not use a training dataset containing the RGB image for training when a value indicating a brightness of the RGB image is at or below a predetermined value.

9. The estimation model generation unit according to claim 1,
wherein the value indicating the brightness is an average value, maximum value or minimum value of the brightness.
